(19) United States
(12) Patent Application Publication
(10) Pub. No.: US 2013/0229007 A1
(43) Pub. Date: Sep. 5, 2013

(54) Two-Sided Counterfeit-Resistant Certificate And Method

(71) Applicant: COMUNIQUEST, INC., Chanhassen, MN (US)

(72) Inventor: James Olson, Chanhassen, MN (US)

(73) Assignee: COMUNIQUEST, INC., Chanhassen, MN (US)

(21) Appl. No.: 13/673,865

(22) Filed: Nov. 9, 2012

Related U.S. Application Data
(63) Continuation-in-part of application No. 12/728,123, filed on Mar. 19, 2010, now abandoned.
(60) Provisional application No. 61/162,199, filed on Mar. 20, 2009.

(51) Int. Cl. G06K 19/06; B42D 15/00

(52) U.S. Cl. CPC G06K 19/06056; B42D 15/00
USPC 283/67; 235/494; 283/85

(57) ABSTRACT

A certificate and method is provided that reduces the likelihood of counterfeiting via photocopier by providing various features that would require the use of a color duplex copier in order to effectively copy the certificate. Requiring the use of a color duplex copier is an effective deterrent because the use of such a device significantly reduces the profit margins of counterfeiting efforts.

### RELATED APPLICATIONS

This application is a Continuation-In-Part of U.S. patent application Ser. No. 12/728,123 entitled Two-Sided Counterfeit-Resistant Certificate and Method filed, Mar. 19, 2010, which claims priority to U.S. Provisional Application Serial No. 61/162,199 filed Mar. 20, 2009 entitled Two-Sided Counterfeit-Resistant Certificate, the contents of both of which is incorporated in their entireties herein.

### BACKGROUND OF THE INVENTION

The advent of high quality, inexpensive color copiers has been a wonderful tool for businesses but an equally useful weapon by individuals inclined to use the technology fraudulently to their advantage. One of the biggest applications of fraud with the new, sophisticated color copiers is utilized in the area of duplicating negotiable documents (i.e. merchandise certificates that are fulfilled and mailed to individuals of consumer products companies' loyalty programs. An individual could, for example, mail in certificates of purchase and in return receive a bar-coded certificate good for a free item (i.e. bottle of soda, pound of candy, etc.). The new color copying technology allows individuals to efficiently and effectively mass produce duplicate copies of the certificate such that the barcode on the copy is accepted by the barcode scanners of the retailers where the certificate is redeemed. The traditional VOID hidden word feature is not enough to deter criminals from copying the certificates because the barcode is still read by the scanners and busy clerks do not tend to notice the screened word “VOID” on the certificate since they are primarily looking for the barcode (and if it successfully scans they accept the certificate) resulting in potentially millions of dollars of loss for the consumer products company. There are literally millions of store clerks who receive these types of certificates so it is important to “foolproof” the document so the vast majority of the time a forged certificate is rejected regardless of who the store clerk is. Therefore, the need is to come up with a document solution that ensures if the clerk doesn't notice the “VOID” screen on the certificate there are additional defense mechanisms in place to ensure the fraudulent document is stopped before redemption takes place.

### SUMMARY OF THE INVENTION

The solution involves a certificate designed for a generic, inoperable barcode on the front of the certificate that cannot be scanned and the actual scannable barcode is printed on the back of the document. In the middle of the inoperable barcode on the face of the document are instructions to the clerk to scan the barcode on the back of the certificate. If the certificate is authentic the process will run smoothly and there will be no issues at the point of redemption as the document will be properly scanned on the back as instructed. If the certificate is a counterfeit that has been reproduced via a photocopying device, the word “VOID” will appear in a bright, distinguishable color throughout the certificate screen. Additionally, as on an authentic certificate, the barcode on the front will not work, requiring the clerk to turn the certificate over as instructed to scan the barcode. Unless a counterfeiter used a duplex color photocopier, there will be no operable barcode on the back of the counterfeit certificate, thus thwarting the efforts to redeem a counterfeit certificate. Using a duplex color copy machine is a more expensive and timely process. Finally, as on the front of the counterfeit certificate, the word “VOID” will appear on the back of the counterfeit certificate in a large step and repeat printed font to draw further attention that the forged document is not real .

### BRIEF DESCRIPTION OF THE DRAWINGS

FIG. 1 is a plan view of a first side of an embodiment of the two-sided certificate of the present invention;

FIG. 2 is a plan view of a second side of an embodiment of the two-sided certificate of the present invention;

FIG. 3 is a perspective view of an attempt at using a copier to duplicate the first side of the two-sided certificate shown in FIG. 1;

FIG. 4 is a perspective view of an attempt at using a copier to duplicate the second side of the two-sided certificate shown in FIG. 2;

FIG. 5 is a plan view of a first side of an embodiment of the two-sided certificate of the present invention; and,

FIG. 6 is a plan view of a second side of an embodiment of the two-sided certificate of the present invention.

### DETAILED DESCRIPTION OF THE INVENTION

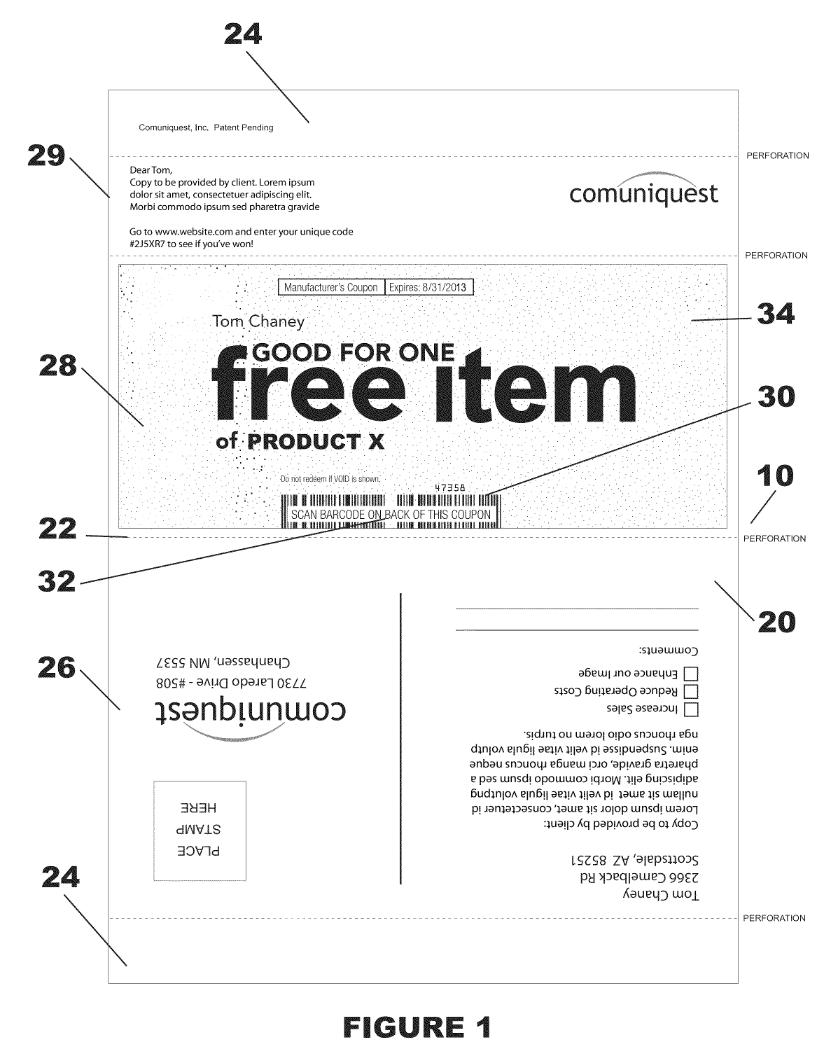

Referring now to the figures, and first to FIG. 1, there is shown a first side 20 of a two-sided certificate 10 of the present invention to be printed on a substrate such as paper, preferably paper having a thickness usable for postcards and the like. The first side 20 includes a fold or perforation line 22 and tear-off areas 24 at either end. On one side of the fold line 22 is designated as a postcard section 26, while the other side is designated as a certificate section 28.

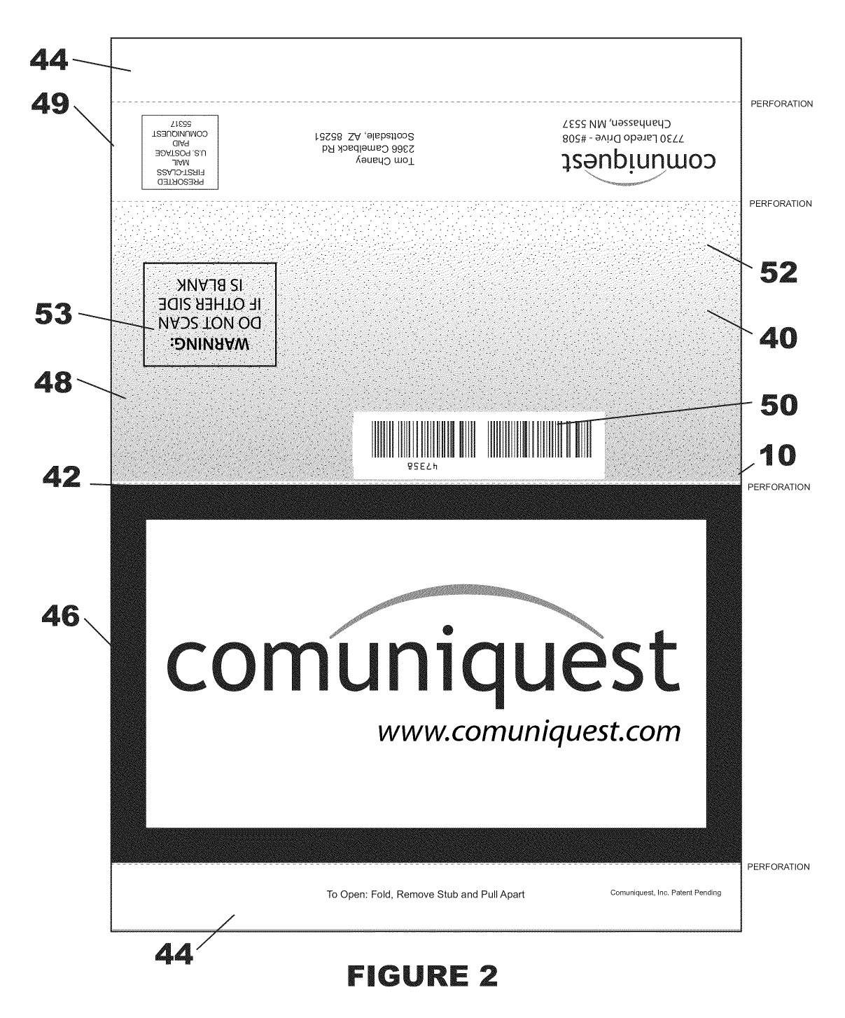

Looking at FIG. 2, there is shown the opposite side 40 of the two-sided certificate 10 of the present invention. The second side 40 includes a fold or perforation line 42, which aligns with the fold or perforation line 22 on the first side 20 of the certificate 10. The second side also has a designated postcard section 46 on one side of the fold line 42 and a designated certificate section 48 on the other side of the fold line 42.

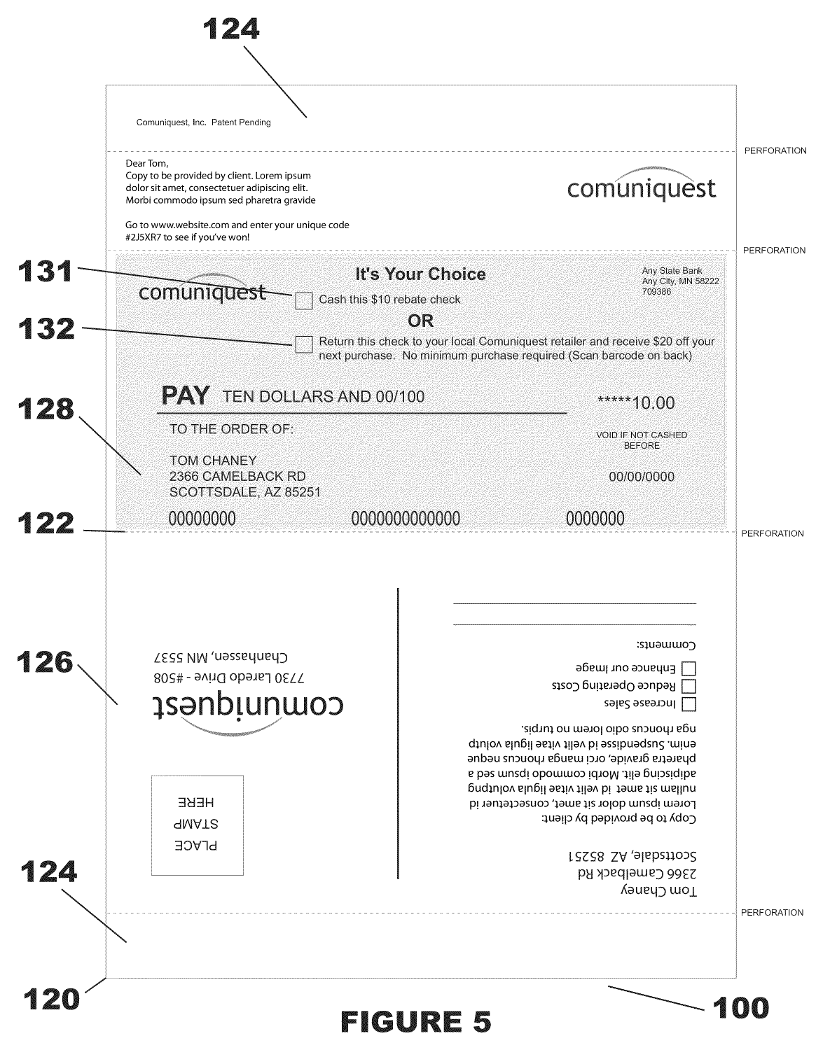

The present invention pertains more particularly to the certificate sections 28 and 48. Certificate section 28 constitutes the front of the certificate and includes informational and/or promotional information about the redemption value of the certificate 10. An inoperable UPC symbol 30 appears but is rendered useless by a white bar 32 running through it that instructs a clerk to scan the second side 48 of the certificate 10. The purpose of the inoperable UPC symbol 30 is merely to direct the attention of a clerk or other certificate processor to the back side 48 of the certificate section. As such, other indicators to scan the UPC code on the back side 48 may be effective, as one skilled in the art will realize. For example, as shown in FIG. 5 and described below, a check version of the present embodiment is provided, which provides written instructions via a selection box to scan a UPC code on the back side.

The symbol 30 may give the appearance of a bar code in order to create confusion on the part of a would-be counterfeiter. The counterfeiter may not realize that the bar code is inoperable, or not an actual barcode, and thus use a single-sided copy, ignoring the actual, functional barcode 50 on the opposite side of the certificate, discussed in more detail below.

The empty space of the certificate section 28 includes a hidden indicator, such as ink dots 34 of at least two colors, one of which is visible to the human eye but invisible to a copier machine, and the other of which is visible to both. This technology is known in the art and is used as a counterfeit deterrent. The color that is visible to the copier is arranged to form the word “Void,” or its functional equivalent, in an inconspicuous manner.

The second certificate section 48 is aligned on the opposite side of the certificate 10 as the first certificate section 28 and, therefore, constitutes the back of the certificate. The second certificate section 48 may be void of information, with the exception of a functional UPC bar code 50. Additionally, the remainder of the second certificate section 48 also includes a hidden indicator, shown by way of example as ink dots 52 similar or identical to those ink dots 34 on the front side 28 of the certificate.

Alternatively or additionally, the functional UPC bar code 50 may be adjacent to a warning 53 to a clerk that the UPC code 50 is not to be scanned without reviewing the front of the certificate to ensure that it is not blank and/or that one or both sides of the certificate are in color.

The first postcard section 26 may be used to provide an easily returnable postcard that the recipient of the certificate 10 may use to communicate or otherwise respond to the issuer of the certificate 10. The second postcard section 46 is filled to establish that it is intentionally blank.

The first and second postcard sections 28 and 48 include first and second recipient section 29 and 49, respectively. The first recipient section 29 provides a space to greet the recipient and convey a message. The second recipient section 49 provides a space for the mailing address of the recipient.

In use the issuer of the certificate 10 prints the certificates 10 and folds them along the perforation line 22 such that the first sections 26 and 28 face each other. Adhesive is applied to join the tear-off areas 24 and 44 such that the two tear off areas 24 on the first side 20 face each other and are joined. Hence, the sections 46 and 48 of the second side 40 become the visible sides of the certificate 10, with mailing information and postage on the recipient section 49 becoming the only significant visible information. This alleviates confusion for the postal service.

Upon receiving the certificate 10, a recipient tears off the tear-off sections and opens the certificate 10 along the fold line 42. A message in the recipient section 29 communicates to the recipient that he or she has received a redeemable certificate and should tear the certificate section from the rest of the document along the fold/tear line 22. After doing so, the recipient is left with a two-sided certificate and a postcard.

The recipient may then apply postage to the postcard and provide communication back to the issuer. The recipient may also bring the resulting two-sided certificate to a vendor and redeem it for goods or services. The vendor, upon being handed the certificate, may try to scan the UPC code 30 but will be unsuccessful and will then notice the instructions to scan the back and to also ensure the word “Void” does not appear anywhere on the certificate. Because the back side 48 of the certificate contains nothing but the bar code 50 and the ink dots 52, if the word “Void” appears, it will be quite obvious.

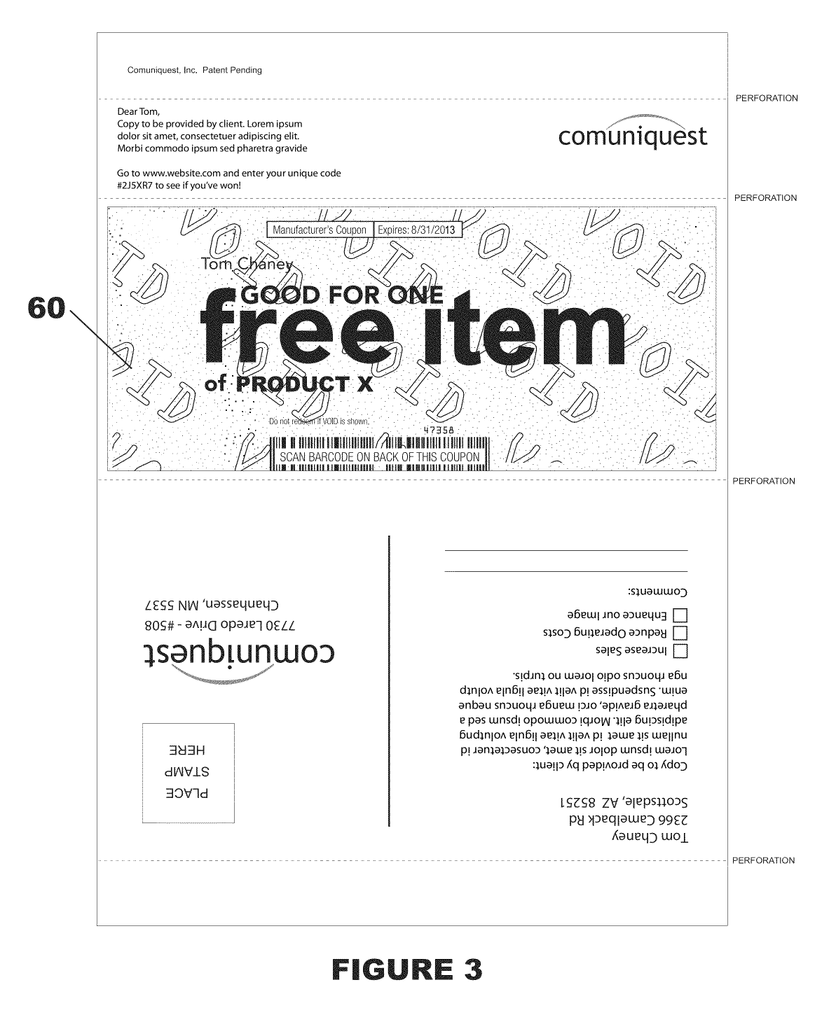

Hence, if one were to make single-sided copies of the front certificate section 28, not only would the word “Void” appear, but the UPC code 30 would not be operable for redemption. An example of the result of such an attempt 60 is provided in FIG. 3.

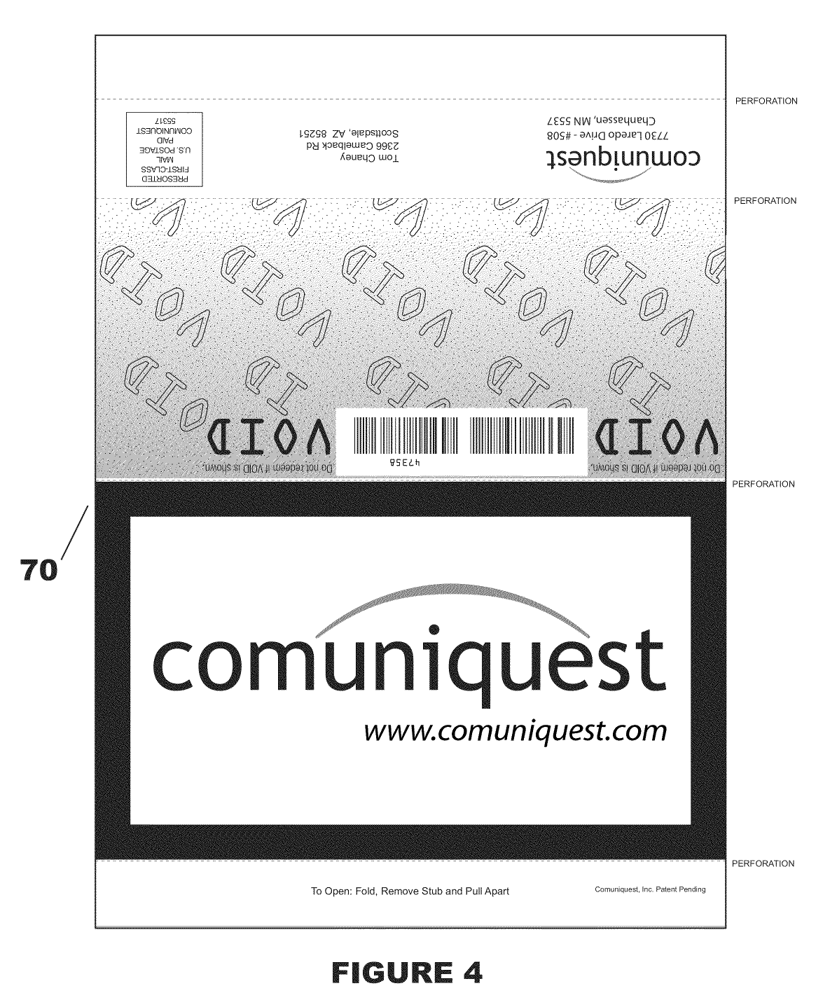

If one were to make single-sided copies of the back certificate section 48, the resulting certificate would look suspicious due to a lack of product information as well as the inconspicuous appearance of the word “Void”. FIG. 4 shows an example 70 of this attempt.

If one were to go to the expense and trouble of making two-sided copies of the certificate, the clerk would likely look closely at the certificate after a possible failed-attempt at scanning the front side 28 UPC code 30 due to the white bar 32. The clerk would then see the word “Void” written on both sides of the document.

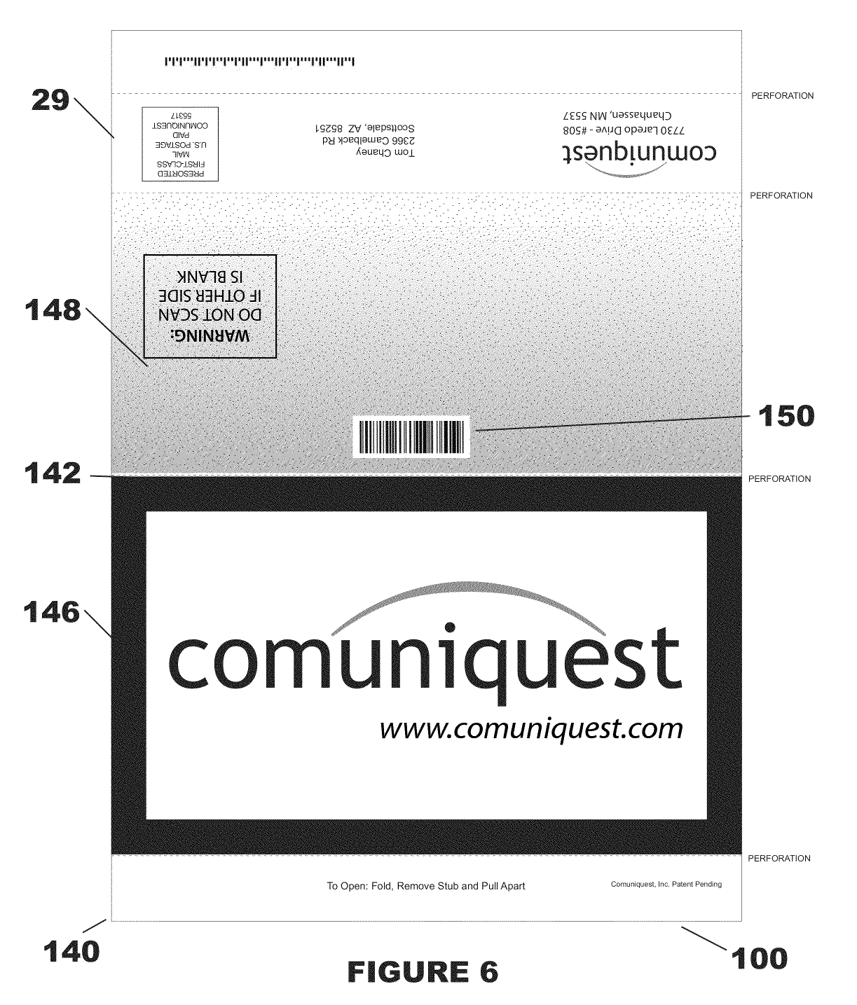

Referring now to FIGS. 5 and 6, a second embodiment 100 of the present invention is shown. There is shown a first side 120 of a two-sided certificate 100 of the present invention. The first side 120 includes a fold or perforation line 122 and tear-off areas 124 at either end. On one side of the fold line 122 is designated as a postcard section 126, while the other side is designated as a certificate section 128.

Looking at FIG. 6, there is shown the opposite side 140 of the two-sided certificate 100 of the present invention. The second side 140 includes a fold or perforation line 142, which aligns with the fold or perforation line 122 on the first side 120 of the certificate 100. The second side also has a designated postcard section 146 on one side of the fold line 142 and a designated certificate section 148 on the other side of the fold line 142.

The present invention pertains more particularly to the certificate sections 128 and 148. Certificate section 128 constitutes the front of the certificate and includes informational and/or promotional information about the redemption value of the certificate 100. A selection box section 130 appears that gives the recipient a choice between using the certificate as a check (via check box 131), or using the certificate as a coupon (via check box 132). Selecting box 131 would require an endorsement on the back side 148 by the recipient. Selecting box 132 directs a clerk to scan a UPC code 150 on the second side 148 of the certificate 100.

The empty space of the certificate section 128 is filled with ink dots 134 of at least two colors, one of which is visible to the human eye but invisible to a copier machine, and the other of which is visible to both. This technology is known in the art and is used as a counterfeit deterrent. The color that is visible to the copier is arranged to form the word “Void,” or its functional equivalent, in an inconspicuous manner.

The second certificate section 148 is aligned on the opposite side of the certificate 10 as the first certificate section 128 and, therefore, constitutes the back of the certificate. The second certificate section 148 may be void of information, with the exception of a functional UPC bar code 150. Additionally, the remainder of the second certificate section 148 is filled with ink dots 152 similar or identical to those ink dots 134 on the front side 128 of the certificate.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A photoduplication-resistant certificate useable for redemption comprising:
a substrate having a first side and a second side;
said first side including redemption information and a feature directing attention to a barcode located on said second side in order to redeem said certificate;
said second side including said barcode.

2. The photoduplication-resistant certificate of claim 1 further comprising a hidden indicator on at least one of said first and second sides; said hidden indicator providing a visual indication of inauthenticity on photocopies of said certificate.

3. The photoduplication-resistant certificate of claim 2 wherein said hidden indicator comprises a word having a meaning equivalent to the English word “void”.

4. The photoduplication-resistant certificate of claim 1 wherein said substrate comprises paper.

5. The photoduplication-resistant certificate of claim 1 wherein said substrate comprises a postcard.

6. The photoduplication-resistant certificate of claim 1 wherein said redemption information and instruction comprise a plurality of colors and include a warning that a monochromatic copy is inauthentic.

7. The photoduplication-resistant certificate of claim 1 wherein said feature directing attention to a barcode located on said second side in order to redeem said certificate comprises an inoperable barcode.

8. The photoduplication-resistant certificate of claim 1 wherein said feature directing attention to a barcode located on said second side in order to redeem said certificate comprises written instructions to use said barcode located on said second side.

10. The photoduplication-resistant certificate of claim 1 further comprising a warning on said second side indicating certificate is not to be scanned if a first side of said certificate is blank.

11. A method of preventing unauthorized duplication of a certificate using a monochromatic, single-sided photocopying device, comprising:
placing a barcode on a second side of said certificate necessary for redemption of said certificate;
directing attention of a clerk scanning said barcode to said second side via a feature on a first side of said certificate.

12. The method of claim 10 further comprising placing a hidden indicator on at least one of said first and second sides; said hidden indicator providing a visual indication of inauthenticity on photocopies of said certificate.

13. The method of claim 12 wherein placing a hidden indicator on at least one of said first and second sides; said hidden indicator providing a visual indication of inauthenticity on photocopies of said certificate comprises placing a hidden indicator comprises placing a warning that becomes visible when duplicated on a monochromatic photocopy device.

14. The method of claim 11 further comprising placing a warning on said second side of said certificate indicating said certificate is not to be scanned if said first side of said certificate is blank.
